(19) United States
(12) Patent Application Publication
(10) Pub. No.: US 2010/0165148 A1
(43) Pub. Date: Jul. 1, 2010

(54) APPARATUS FOR IMPROVING IMAGE QUALITY AND METHOD THEREOF

(76) Inventor: Kyoung-Hyoun Kwak, Gangseo-gu (KR)

Correspondence Address: SHERR & VAUGHN, PLLC, 620 HERNDON PARKWAY, SUITE 320, HERNDON, VA, 20170, US

(21) Appl. No.: 12/646,550

(22) Filed: Dec. 23, 2009

(30) Foreign Application Priority Data
Dec. 29, 2008 (KR) 10-2008-0135285

(51) Int. Cl. H04N 5/76; H04N 5/228; H04N 5/217

(52) U.S. Cl. 348/231.99; 348/222.1; 348/241; 348/E05.031; 348/E05.078

(57) ABSTRACT

An apparatus for improving an image quality and method thereof includes a digital camera outputting either a first image signal non-processed or a second image signal processed by a first control signal by converting image information to digital information, an image streaming device storing either the first image signal or the second image signal outputted from the digital camera, the image streaming device outputting the first control signal by processing the second control signal, and a data processor comparing a target value to either the first or second image signal stored in the image streaming device, the data processor outputting the second control signal having an error value according to a result of the comparison.

The present application claims priority under 35 U.S.C. §119 to Korean Patent Application No. 10-2008-0135285 (filed on Dec. 29, 2008), which is hereby incorporated by reference in its entirety.

### BACKGROUND

FIG. 1 illustrates a method of improving an image quality of a digital camera.

As illustrated in FIG. 1, if a shutter of digital camera 10 is pressed, image information IMG of a subject is delivered to image sensor 12 having a lens of digital camera 10 provided thereto. Image sensor 12 converts image information IMG to digital information under the control of control data CTRL_DATA delivered from image signal processing unit 14 and then outputs non-processed raw image signal R_IMG. Image signal processing unit 14 of digital camera 10 stores raw image signal R_IMG or processed image signal P_IMG, which is processed by image quality improvement, as set information in memory 20.

A user moves raw image signal R_IMG or processed image signal P_OMG stored in memory 20 to data processor 30, analyses and handles raw image signal R_IMG or processed image signal P_IMG through data processor 30, processes the corresponding result into binary type ROM data ROM_DATA, and then records it in image signal processing unit 14. Subsequently, image signal processing unit 14 updates processed image signal P_IMG with information set by ROM data ROM_DATA. The above process is repeatedly performed until the updated processed image signal P_IMG has a user's target image quality.

However, as the user performs the above process repeatedly to obtain an optimal image quality, it consumes a considerable period of time to cause considerable cost and inconvenience for the corresponding work. Moreover, since the user is always involved in the repetitive executions of the above process, it may be difficult to obtain the same result all the time according to user's determination, mistakes, skills and the like. Besides, error can be caused in the course of performing the process.

### SUMMARY

Embodiments relates to an image quality improving apparatus, and more particularly, to an apparatus for improving an image quality and method thereof. Although embodiments are suitable for a wide scope of applications, it is particularly suitable for improving an image quality of a digital camera.

Embodiments relates to an apparatus for improving an image quality and method thereof, by which productivity per unit time can be raised in performing an image improving work of a digital camera and by which error can be minimized.

In accordance with embodiments, an apparatus for improving an image quality can include at least one of the following: a digital camera outputting either a first image signal non-processed or a second image signal processed by a first control signal by converting image information to digital information, an image streaming device storing either the first image signal or the second image signal outputted from the digital camera, the image streaming device outputting the first control signal by processing the second control signal, and a data processor comparing a target value to either the first or second image signal stored in the image streaming device, the data processor outputting the second control signal having an error value according to a result of the comparison.

In accordance with embodiments, the digital camera can include at least one of the following: an image sensor converting the image information to the digital information to output the first image signal and an image signal processing unit receiving and outputting the first image signal or the second image signal processed by the first control signal.

In accordance with embodiments, the image streaming device can include at least one of the following: a frame memory storing either the first or second image signal outputted from the digital camera and a microcontroller outputting the first control signal for image improvement by processing the second control signal.

In accordance with embodiments, the data processor analyzes and extracts either the first or second image signal stored in the image streaming device and then calculates the error value indicating an error extent by comparing the extracted value to the target value.

In accordance with embodiments, if the extract value is substantially equal to the target value, the data processor outputs a work end signal externally. And, the data processor calculates an image quality improving value and then converts the calculated value to ROM data.

In accordance with embodiments, a method of improving an image quality can include at least one of the following: converting image information to either a first image signal non-processed or a second image signal processed according to an error value, storing either the converted first or second image signal, analyzing a value of the analyzed first or second image signal, comparing the analyzed value to a target value, if the value of either the analyzed first or second image signal fails to match the target value, calculating the error value and then applying the calculated error value to the second image signal, and if the value of either the analyzed first or second image signal matches the target value, calculating an image quality improving value and then ending this routine.

In accordance with embodiments, the converting, storing and comparing steps are repeatedly performed until the value of either the analyzed first or second image signal matches the target value.

In accordance with embodiments, if the value of either the analyzed first or second image signal matches the target value, the calculated image quality improving value is stored as ROM data.

In accordance with embodiments, an apparatus for improving an image quality can include at least one of the following: a digital camera configured to output one of a first image signal non-processed and a second image signal processed by a first control signal by converting image information to digital information; an image streaming device configured to store one of the first image signal and the second image signal output from the digital camera, the image streaming device also configured to output the first control signal by processing the second control signal; and a data processor configured to compare a target value to one of the first image signal and the second image signal stored in the image streaming device, the data processor also configured to output the second control signal having an error value in accordance with result of the comparison.

In accordance with embodiments, an apparatus for improving an image quality can include at least one of the following: a digital camera configured to output one of a first image signal non-processed and a second image signal processed by a first control signal by converting image information to digital information, the digital camera including an image sensor configured to convert the image information to the digital information to output the first image signal; an image streaming device configured to store one of the first image signal and the second image signal output from the digital camera, the image streaming device also configured to output the first control signal by processing the second control signal the image streaming device including a frame memory configured to store one of the first image signal and the second image signal output from the digital camera; and a data processor configured to compare a target value to one of the first image signal and the second image signal stored in the image streaming device, the data processor also configured to output the second control signal having an error value in accordance with result of the comparison.

In accordance with embodiments, a method of improving an image quality can include at least one of the following: converting image information to one of an unprocessed first image signal and a processed second image signal in accordance with an error value; storing one of the converted first image signal and the second image signal; analyzing a value of one of the first image signal and the second image signal; comparing the analyzed value to a target value; calculating an error value if the analyzed value of one of the first image signal and the second image signal fails to match the target value; applying the calculated error value to the second image signal; and then calculating an image quality improving value if the analyzed value of one of the first image signal and the second image signal matches the target value.

Accordingly, embodiments provides the following effects and/or advantages.

The image quality improving apparatus and method enhances work productivity by automating work manually performed by a worker as an image shift, image analysis, digital camera software update and the like. Secondly, the image quality improving apparatus and method by which an image quality improving work can be automatically performed. Therefore, the embodiments prevents error from being caused by insufficient sill of a worker and obtains the same result all the time.

### DRAWINGS

FIG. 1 illustrates an image quality improving device.

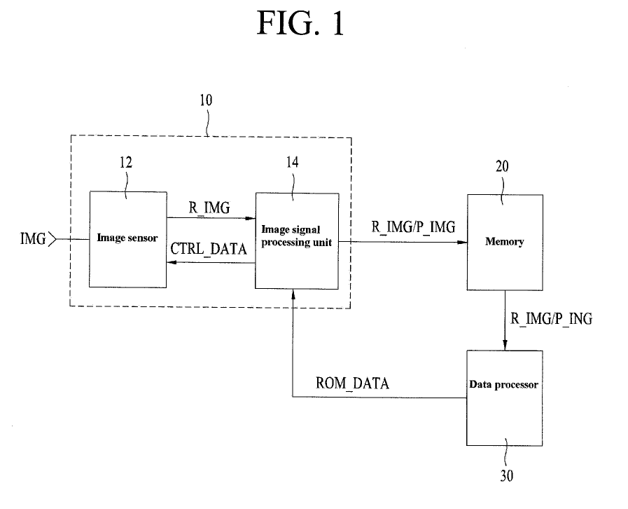

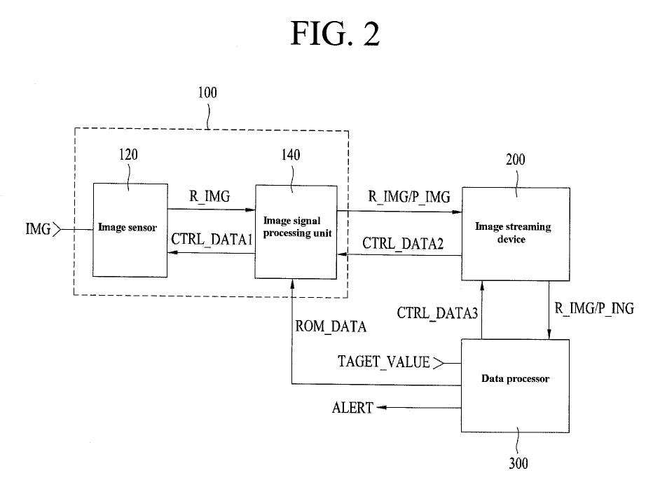

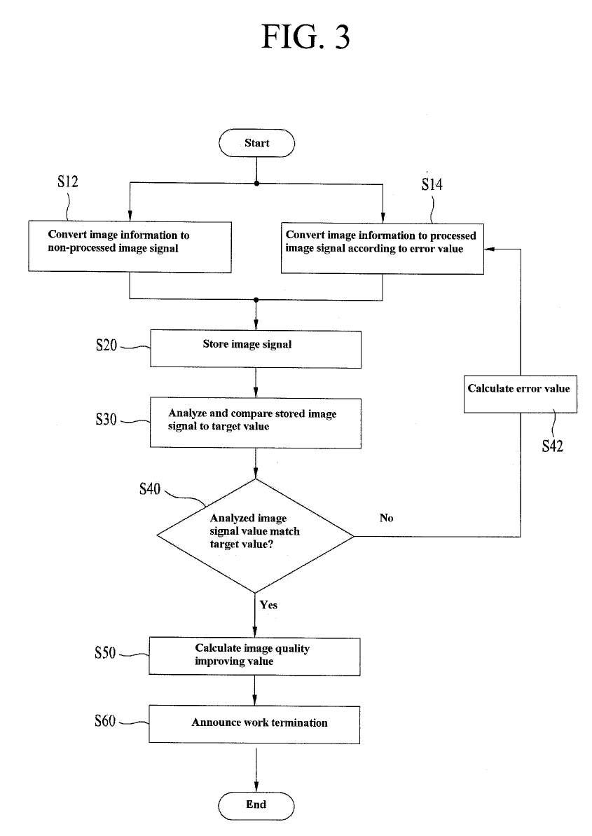

Example FIGS. 2 and 3 illustrate an apparatus for improving an image quality and a method of improving an image quality, in accordance with embodiments.

### DESCRIPTION

Reference will now be made in detail to preferred embodiments, examples of which are illustrated in the accompanying drawings. Wherever possible, the same reference numbers will be used throughout the drawings to refer to the same or like parts.

Embodiments relate to an image quality improving apparatus and method for automatically updating an image quality of an image signal by comparing a target value set by a worker and an analysis value of the image signal outputted from a digital camera.

As illustrated in example FIG. 2, an image quality improving apparatus in accordance with embodiments includes digital camera 10, image streaming device 200 and data processor 300. Digital camera 100 includes image sensor 120 and image signal processing unit 140. Image sensor 120 includes a lens. Image sensor 120 converts image information IMG of a subject to digital information and then outputs non-processed raw image signal R_IMG under the control of control data CTRL_DATA1 provided by image signal processing unit 140.

Image signal processing unit 140 receives raw image signal R_IMG provided by image sensor 120 and then outputs it as it is. Alternatively, image signal processing unit 140 outputs processed image signal P_IMG, in which an image quality of raw image signal R_IMG is improved by control data CTRL_DATA2 provided by image streaming device 200 or ROM data ROM_DATA provided by data processor 300. Moreover, image signal processing unit 140 outputs control data CTRL_DATA1 for controlling image sensor 120 to image sensor 120.

Image streaming device 200 includes a frame memory and microcontroller (MCU). Raw image signal R_IMG or processed image signal P_IMG is stored using the frame memory. Image streaming device 200 processes control data CTRL_DATA3 provided by data processor 300 through the microcontroller and then outputs control data CTRL)DATA2.

Data processor 300 includes software for receiving raw image signal R_IMG or processed image signal P_IMG stored in image streaming device 200 via communication port standardized by USG (universal serial bus), IEEE.1394 and the like and analyzes and extracts received raw image signal R_IMG or received processed image signal P_IMG. Data processor 300 compares target value TARGET_VALUE previously inputted by a worker to a value of the extracted raw or processed image signal R_IMG or P_IMG and then outputs control data CTRL_DATA3 having error value information according to the comparison result. When the error value exists within a range set by the worker, data processor 300 outputs signal ALERT informing the work that the work is ended. And, data processor 300 converts the finally calculated result to binary type ROM data ROM_DATA usable for digital camera 100 and then delivers the ROM data to image signal processing unit 140. In this case, data processor 300 can correspond to a personal computer (PC).

An image quality improving apparatus in accordance with embodiments performs an image quality improving work in a flow shown in example FIG. 3.

An image quality improving method in accordance with embodiments is explained with reference to example FIGS. 2 and 3 as follows.

First, image information IMG is converted to raw image signal R_IMG via digital camera 100 [S12] or processed image signal P_IMG according to an error value [S14]. Converted image signal R_IMG or processed image signal P_IMG is stored via image streaming device 200 [S20]. Stored image signal R_IMG or processed image signal P_IMG is analyzed through data processor 300. The analyzed value is compared to target value TARGET_VALUE [S30].

If the value of analyzed image signal R_IMG or processed image signal P_IMG does not match target value TARGET_VALUE [S40], an error value is calculated via data processor 300 [S42]. The calculated error value is applied to digital camera 100. This process is repeatedly performed until the value of analyzed image signal R_IMG or P_IMG matches target value TARGET_VALUE. If the value of analyzed image signal R_IMG or P_IMG matches target value TARGET_VALUE [S40], an image quality improving value is calculated via data processor 300 [S50]. A work end announcement is outputted [S60].

Moreover, the calculated image quality improving value is converted to ROM data ROM_DATA and can be then delivered to image signal processing unit 140. And, image signal P_IMG, of which image quality is finally optimized through ROM data ROM_DATA, can be outputted. Thus, the image quality improving apparatus and method in accordance with embodiments automatically update an image quality of digital camera 100 by image streaming device 200 and data processor 300. Accordingly, work efficiency becomes better than that of a manual work conducted by a worker. Error occurring in iterative execution can be minimized. And, the same result can be obtained owing to a consistent work progress.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a digital camera configured to output one of a first image signal non-processed and a second image signal processed by a first control signal by converting image information to digital information;
an image streaming device configured to store one of the first image signal and the second image signal output from the digital camera, the image streaming device also configured to output the first control signal by processing the second control signal; and
a data processor configured to compare a target value to one of the first image signal and the second image signal stored in the image streaming device, the data processor also configured to output the second control signal having an error value in accordance with result of the comparison.

2. The apparatus of claim 1, wherein the digital camera comprises:
an image sensor configured to convert the image information to the digital information to output the first image signal.

3. The apparatus of claim 2, wherein the digital camera comprises:
an image signal processing unit configured to receive and output one of the first image signal and the second image signal processed by the first control signal.

4. The apparatus of claim 1, wherein the digital camera comprises:
an image signal processing unit configured to receive and output one of the first image signal and the second image signal processed by the first control signal.

5. The apparatus of claim 1, wherein the image streaming device comprises:
a frame memory configured to store one of the first image signal and the second image signal output from the digital camera.

6. The apparatus of claim 5, wherein the image streaming device comprises:
a microcontroller configured to output the first control signal for image improvement by processing the second control signal.

7. The apparatus of claim 1, wherein the image streaming device comprises:
a microcontroller configured to output the first control signal for image improvement by processing the second control signal.

8. The apparatus of claim 1, wherein the data processor is configured to analyze and extract one of the first image signal and the second image signal stored in the image streaming device and then calculate the error value indicating an error extent by comparing the extracted value to the target value.

9. The apparatus of claim 8, wherein if the extract value is substantially equal to the target value, the data processor outputs a work end signal externally.

10. The apparatus of claim 9, wherein the data processor is configured to calculate an image quality improving value and then convert the calculated value to ROM data.

11. A method comprising:
converting image information to one of an unprocessed first image signal and a processed second image signal in accordance with an error value;
storing one of the converted first image signal and the second image signal;
analyzing a value of one of the first image signal and the second image signal;
comparing the analyzed value to a target value;
calculating an error value if the analyzed value of one of the first image signal and the second image signal fails to match the target value;
applying the calculated error value to the second image signal; and then
calculating an image quality improving value if the analyzed value of one of the first image signal and the second image signal matches the target value.

12. The method of claim 11, wherein converting image information, storing one of the converted first image signal and the second image signal and comparing the analyzed value to a target value are repeatedly performed until the analyzed value of one of the first image signal and the second image signal matches the target value.

13. The method of claim 11, wherein the calculated image quality improving value is stored as ROM data if the analyzed value of one of the first image signal and the second image signal matches the target value.

14. An apparatus comprising:
a digital camera configured to output one of a first image signal non-processed and a second image signal processed by a first control signal by converting image information to digital information, the digital camera including an image sensor configured to convert the image information to the digital information to output the first image signal;
an image streaming device configured to store one of the first image signal and the second image signal output from the digital camera, the image streaming device also configured to output the first control signal by processing the second control signal the image streaming device including a frame memory configured to store one of the first image signal and the second image signal output from the digital camera; and
a data processor configured to compare a target value to one of the first image signal and the second image signal stored in the image streaming device, the data processor also configured to output the second control signal having an error value in accordance with result of the comparison.

15. The apparatus of claim 14, wherein the digital camera comprises:
an image signal processing unit configured to receive and output one of the first image signal and the second image signal processed by the first control signal.

16. The apparatus of claim 15, wherein the image streaming device comprises:
a microcontroller configured to output the first control signal for image improvement by processing the second control signal.

17. The apparatus of claim 14, wherein the data processor is configured to analyze and extract one of the first image signal and the second image signal stored in the image streaming device and then calculate the error value indicating an error extent by comparing the extracted value to the target value.

18. The apparatus of claim 17, wherein if the extract value is substantially equal to the target value, the data processor outputs a work end signal externally.

19. The apparatus of claim 18, wherein the data processor is configured to calculate an image quality improving value and then convert the calculated value to ROM data.

20. The apparatus of claim 14, wherein the apparatus comprises an apparatus for improving an image quality.
